(19) United States
(12) Patent Application Publication
(10) Pub. No.: US 2005/0044770 A1
(43) Pub. Date: Mar. 3, 2005

(54) Two barreled ferrule fishing lure

(76) Inventor: Darcy Linklater, Starbuck, WA (US)

Correspondence Address: Floyd E. Ivey;Liebler, Ivey, Connor & Berry, P.O. Box 6125, Kennewick, WA, 99336, US

(21) Appl. No.: 10/654,854

(22) Filed: Sep. 3, 2003

(51) Int. Cl. A01K 85/00

(52) U.S. Cl. 43/42.11; 43/42.19

(57) ABSTRACT

A fishing lure with a lure shaft interconnected to a primary shaft. The lure shaft impales or skewers a lure or bait. A double barreled ferrule is affixed by a first barrel to the primary shaft. A second barrel receives the first end of the lure shaft thereby locking it in position to lessen the likelihood of loss of the lure or bait.

### FIELD OF THE INVENTION

The present invention relates to fishing lures and more particularly the manner of securing bait to a lure and hook assembly.

### BACKGROUND OF THE INVENTION

Fishing lures are a well-known in the fishing arts. Fish-shaped metal lures were in use in Europe before Christopher Columbus set sail and discovered the New World. Archeological evidence shows that Native Americans tied feathers and other ornamentation on hooks they fashioned from bone and stone in order to catch fish. In 1852, the first known U.S. patent for an artificial fishing lure a metal “spoon” was issued to J. T. Buell of Whitehall, N.Y. Until this time, sport fishing relied on the use of hooks and bait. By the early 1900's, wood lures became more popular than metal lures, with manufacturing companies opening up all over the northeastern United States. Wood lures used innovative hardware to attach the hooks, and the use of other metal parts such as propellers to make the wood lure spin or vibrate, “noses” or “lips” to make the lure dive, or “flaps” to make the lure crawl on the water surface. By the middle 1900's plastic lures began to be used along with wood lures and as time progressed the plastic or rubber lures replaced the wood lures.

One type of lure is a spinner. When a regular pork rind or worm lure will not attract a fish, it often happens that the addition of a small spinner with its glittering movement is successful. A spinner consists of a shaft and clevis upon which the blade is mounted. In order to successfully use a lure or fish bait the bait must remain on the hook when it is cast into the water and for at least a sufficient time for the fish to be attracted to the bait and be hooked. The problem of“throwing off” the bait or having the fish remove the bait from the hook and evades being hooked has been partially addressed in U.S. Pat. No. 3,992,801 to McDiarmid et al which discloses a safety pin holding means for securing the bait on the hook. The safety pin holding means secures less than half of the body of the bait securing approximately 25 to 40 percent of the bait. In a second embodiment of U.S. Pat. No. 3,992,801 a cross pin means is seen. U.S. Pat. No. 3,992,801 does not insure that bait will not be “thrown off” or picked off by a fish.

### SUMMARY OF THE INVENTION

The present invention minimizes and in some aspects eliminates several of the disadvantages of the related art. Disclosed in the present invention is a bait fastener formed of a lure shaft, having a spring function, interconnected to a primary shaft. The lure shaft extends through the entire body of the lure. A fishing hook is affixed to the primary shaft proximal the interconnection of the lure shaft and the primary shaft. A double barreled ferrule with a first barrel, secured to the primary shaft, has a second barrel which receives the lure shaft distal from the interconnection with the primary shaft, thus securely affixing the lure and reducing the likelihood that the lure will be “thrown off”. The fishing hook is affixed by ferrule means to the primary shaft.

### BRIEF DESCRIPTION OF THE DRAWINGS

FIG. 1 is a perspective view of the fishing lure illustrating the primary shaft interconnected with the lure shaft, the double barreled ferrule and a fishing hook affixed by a ferrule to the primary shaft. Also seen is a lure shown as a lizard.

FIG. 2 is a side elevation of the fishing lure showing the lure pierced by the lure shaft and the lure shaft secured in the second barrel of the double barrel ferrule. Also seen are beads and a spinner.

### DETAILED DESCRIPTION

For the purposes of promoting an understanding of the principles in accordance with the invention, reference will now be made to the embodiments illustrated in the drawings and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would normally occur to one skilled in the relevant art and having possession of this disclosure, are to be considered within the scope of the invention claimed.

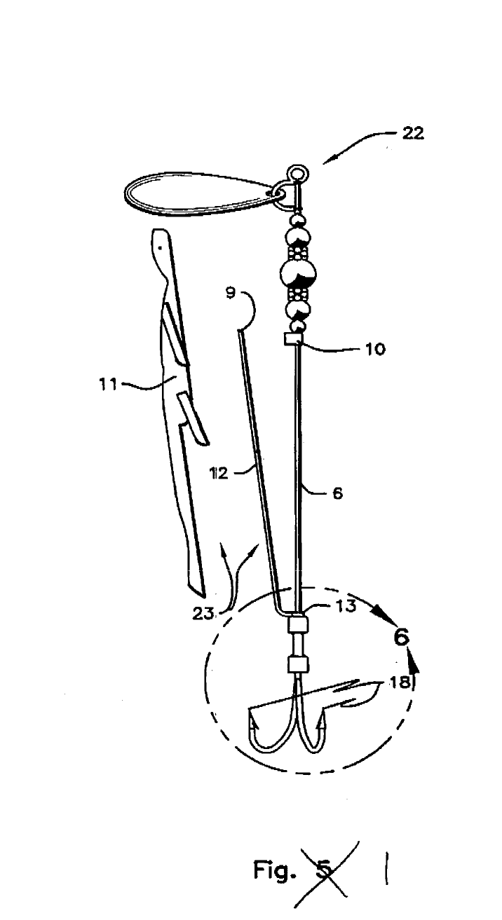

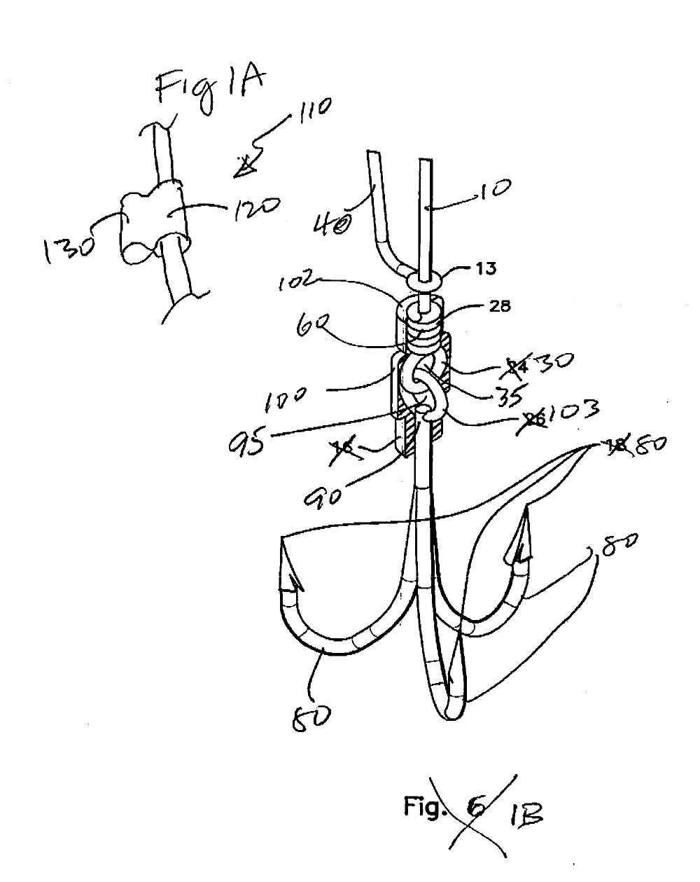

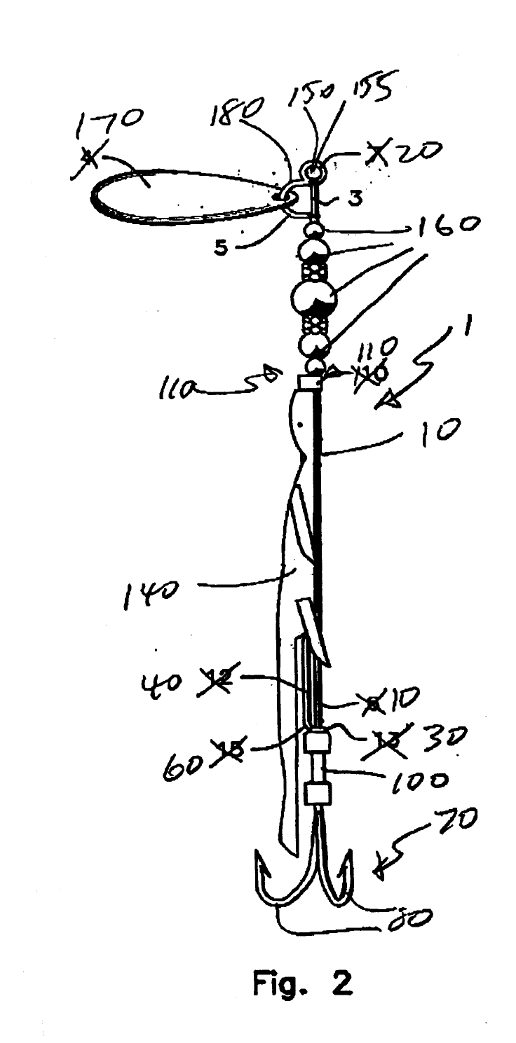

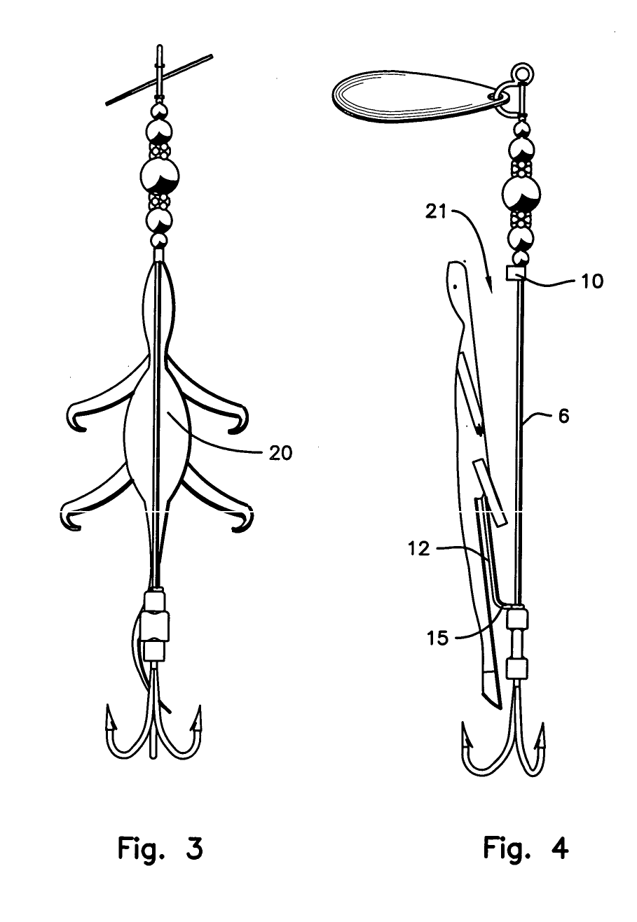

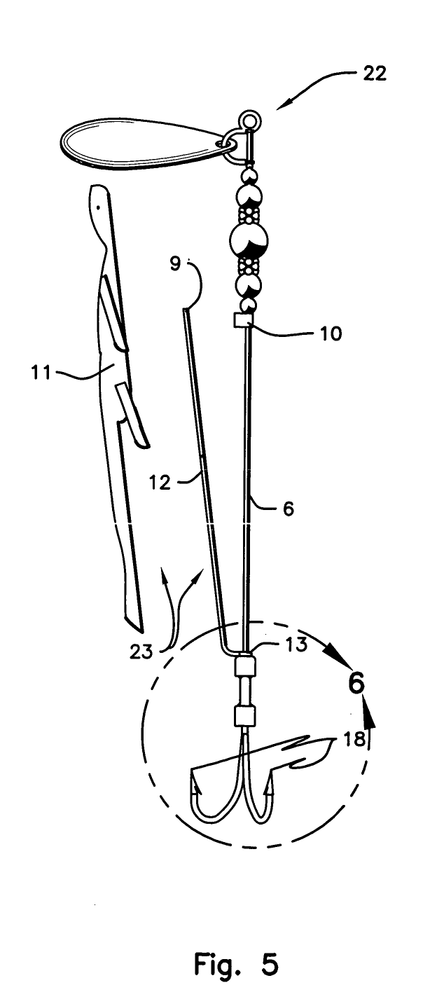

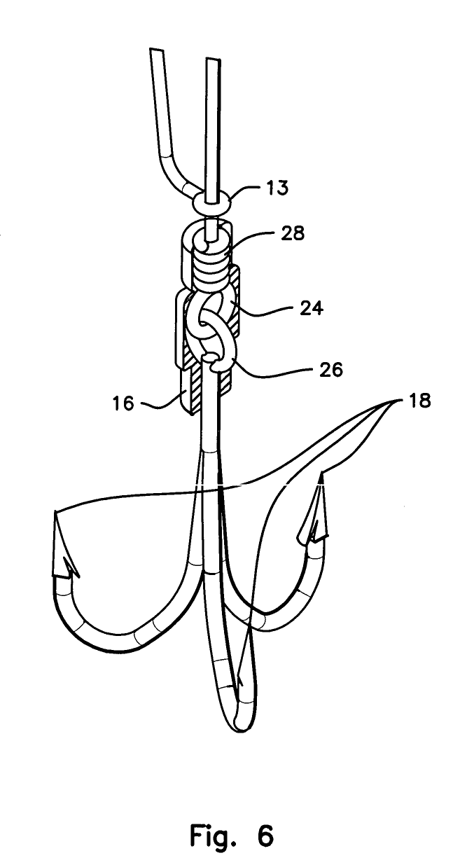

As seen in FIGS. 1, 1A, 1B and FIG. 2, the fishing lure (1) invention of the present application comprises an elongated primary shaft (10) having a first end (20) and a second end (30). An elongated lure shaft (40) having a lure shaft first end (50) and a lure shaft second end (60). The lure shaft second end (60) is interconnected by shaft interconnection means to the primary shaft (10) proximal the second end (30). A fish hook means (70) has a hook shaft (90) which is secured by hook shaft affixing means (100) to the primary shaft (10) proximal the second end (30). Lure shaft locking means (110) is positioned proximal the first end (20) to secure the lure shaft first end (50) when a lure or bait has been skewered onto the lure shaft (40). Fishing leader affixing means (150), to receive fishing leader, is positioned proximal the first end (20) and is comprised, in the preferred embodiment of an eye (155).

The elongated primary shaft (10) and the lure shaft (40) are composed of a rigid material generally composed of metal wire and, in the preferred embodiment of a wire having a copper or tobacco color. The lure shaft (40) is connected to the primary shaft (10) by shaft interconnection means which includes, but as will be recognized by those of ordinary skill in interconnection arts is not limited to welding, wire wrap, wire twist, and ferrule. In the preferred embodiment, as seen in FIG. 1B, the primary shaft (10) and lure shaft (40) are composed of a segment of wire with a wire twist to form the interconnection and thereby define the primary shaft (10), first end (20) and second end (30) and the lure shaft (40), the lure shaft first end (50) and the lure shaft second end (60).

The hook shaft (90) is affixed by hook shaft affixing means includes but is not limited to welding, wire wrap, wire twist or ferrule. In the preferred embodiment hook shaft affixing means is by a ferrule (100) having a first ferrule end (102) and a second ferrule end(103). The hook shaft (90) is, in the preferred embodiment, affixed to the primary shaft (10) by a the first ferrule end (102) receiving the primary shaft (10) at the second end (30) and the second ferrule end (103) receiving the hook shaft (90). The ferrule (100) is secured, in the preferred embodiment, by crimping means to secure the ferrule (100) to the primary shaft (10) and to the hook shaft (90). The hook shaft (90) may additionally terminate in a shaft eye (95) which, in a manufacturing process known in the art, may be interconnected to an eye formed at the primary shaft (10) and depicted, in FIG. 1B as the primary shaft eye (35). Where such eye interconnection is found the ferrule (100) may be of a pliable material including rubber, plastic and other such equivalent materials.

The lure shaft (10) locking means is, in the preferred embodiment, by ferrule means comprised of a double barrel ferrule (110) with the double barrel ferrule (110) having a first barrel (120) receiving and securing the primary shaft (10) proximal the first end (20) and having a second barrel (130) receiving the lure shaft (40) at the lure shaft first end (50).

The lure shaft (40), in the preferred embodiment, has a spring function urging the lure shaft (40) away from the primary shaft (10) when the lure shaft (40) is received into the second barrel (130). The spring function aiding in securing the lure shaft (40) in the second barrel (130).

The fishing lure (1) is further embellished with at least one bead (160), for additional attraction of fish where the at least one bead (160) may be of any color or shape. The bead (160) or beads (160) are generally proximal the primary shaft first end (20). The bead or beads (160) are, in the preferred embodiment, received by the primary shaft (10) intermediate the double barreled ferrule (110) and the first end (20). Additionally, one or more spinners (170) are received by the primary shaft (10) with the one or more spinners (170) generally, in the preferred embodiment, affixed by spinner affixing means intermediate the at least one bead (160) and the first end (20). Spinner affixing means, as will be appreciated by those of ordinary skill in the fishing arts, will include but not be limited to a spinner ring (180).

The lure bait (140) may be made of any inorganic material and may have any shape, size, or configuration that will attract fish. The lure bait (140) may also be live or dead organic bait of any type. The lure (140) is suspended or skewered on the lure shaft (40). Once the lure bait (140) is pierced by the lure shaft (40) the lure shaft first end (50) is then received by the double barrel ferrule (110) at the second barrel (130) with the interaction of the lure shaft first end (50) and the second barrel (130) locking the lure shaft first end (50) and securing it from disengaging and thereby allowing release of the lure bait (140).

It is to be understood that the above-described arrangements are only illustrative of the application of the principles of the present invention. Numerous modifications and alternative arrangements may be devised by those skilled in the art without departing from the spirit and scope of the present invention and the appended claims are intended to cover such modifications and arrangements. Thus, while the present invention has been shown in the drawings and fully described above with particularity and detail in connection with what is presently deemed to be the most practical and preferred embodiment(s) of the invention, it will be apparent to those of ordinary skill in the art that numerous modifications, including, but not limited to, variations in size, materials, shape, form, function and manner of operation, assembly and use may be made without departing from the principles and concepts set forth herein.

1. A fishing lure comprising:
a. an elongated primary shaft having a first end and a second end;
b. an elongated lure shaft having a lure shaft first end and a lure shaft second end;
c. the lure shaft at the lure shaft second end fixedly interconnected by shaft interconnection means to the primary shaft proximal the second end;
d. a fish hook means having a book shaft; the hook shaft secured by hook shaft affixing meats to the primary shaft proximal the second end;
e. lure shaft locking means proximal the first end to secure the lure shaft first end; means proximal the first end to receive fishing leader:
f. the lure shaft sized to receive a lure or a bate; the bate secured from “throw off” by the lure shaft at the lure shaft first end being received by the locking means.

2. The fishing lure according to claim 1 further comprising:
a. the elongated primary shaft and the lure shaft are composed of a rigid material;
b. the shaft interconnection means is by welding, wire wrap, wire twist, or ferrule;
c. hook shaft affixing means to the primary shaft is by welding, wire wrap, wire twist or ferrule;
d. lure shaft locking means is by ferrule means.

3. The fishing lure according to claim 2 further comprising:
a. the rigid material composing the primary shaft and the lure shaft formed from metal wire;
b. the shaft interconnection means is by wire twist of the lure shaft proximal the lure shaft second end about the primary shaft proximal the second end;
c. the lure shaft locking means is by a double barrel ferrule; the double barrel ferrule having a first barrel receiving and securing the primary shaft proximal the first end and having a second barrel receiving the lure shaft at the lure shaft first end;
d. the hook shaft affixing means to the primary shaft is by a ferrule having a first ferrule end and a second ferrule end; the first ferrule end receiving the primary shaft at the second end; the second ferrule end receiving the hook shaft; crimping means to secure the ferrule to the primary shaft and to the hook shaft.

4. The fishing lure according to claim 3, further comprising:
a. the metal wire is a tobacco colored wire;
b. the lure shaft having a spring function urging the sure shaft away from the primary shaft when the lure shaft (40) is received into the second barrel (130).

5. (Cancelled)
